(19) United States
(12) Patent Application Publication
(10) Pub. No.: US 2016/0150793 A1
(43) Pub. Date: Jun. 2, 2016

(54) ADDITIVE THAT CONFERS BIOCIDAL PROPERTIES TO DIFFERENT MATERIALS, SUCH AS NATURAL OR SYNTHETIC, THERMOPLASTIC OR THERMOSTABLE, POLYMERIC RESINS, ORGANIC COATINGS, PAINTINGS, VARNISHES, LACQUERS, COATINGS, GELS, OILS, WAXES, CERAMICS, AMONG OTHERS

(71) Applicant: UNIVERSIDAD DE CHILE, Santiago (CL)

(72) Inventors: Humberto Cristian PALZA CORDERO, Santiago (CL); Katherine Andrea DELGADO VARGAS, Santiago (CL)

(73) Assignee: UNIVERSIDAD DE CHILE, Santiago (CL)

(21) Appl. No.: 14/907,128

(22) PCT Filed: Jul. 21, 2014
(86) PCT No.: PCT/IB2014/063280

§ 371 Date: Jan. 22, 2016

(30) Foreign Application Priority Data
Jul. 23, 2013 (CL) 2101-2013

(51) Int. Cl. A01N 59/20; A01N 25/08

(52) U.S. Cl. CPC A01N 59/20; A01N 25/08

(57) ABSTRACT

The present invention is related to an additive with biocidal properties based on an active agent with antimicrobial and antifouling properties, wherein the additive corresponds to a supporting material, inert substrate or carrier, which has been modified with antimicrobial agents. The invention further describes the method for modifying the supporting material, inert substrate or carrier, with antimicrobial agents. The resulting additives have a biocidal activity, and can be incorporated in different matrices, such as polymeric resins, either natural or synthetic, thermoplastic or thermostable, organic coatings, ceramics, paintings, varnishes and coatings, granting biocidal activity to those matrices.

### TECHNICAL FIELD

The present invention describes an additive that confers biocidal properties to different materials, such as natural or synthetic, thermoplastic or thermostable, polymeric resins, organic coatings, paintings, varnishes, lacquers, coatings, gels, oils, waxes, ceramics, that are widely applicable to different industries. The present invention also is related with the fabrication process of the biocidal additive and its formulations.

### BACKGROUND

Currently, microbial growth and cross-contamination control is fundamental in practically every aspect of life and all environments, from industrial sectos, such as for example where food is processed and consumed, to residential or public places such as hospitals, clinics, schools, universities, shopping centers, and gymnasiums. Bad hygiene practices and their consequences in people health, such as infections or diseases, have pushed a great demand for products incorporating among their features a biocidal activity. In this context is that the present invention is directed to provide a solution to confer an excellent biocidal activity to diverse materials with a wide range of application.

In the health field, hospital-acquired infections (HAI) are common in hospitals, which main transmission mechanism occurs through personnel, paramedics, patients, and visitors hands, since they transport bacteria from a contaminated surface to a clean surface. HAIs generate great health problems at a worldwide level, increasing mortality, morbidity (amount of people or individuals considered sick or victims of a disease in a determined space and time) and hospitalization costs. One of the strategies used to decrease these problems has been replacing conventional materials by materials with biocidal properties. Kenaway et al described that neatly 50% of HAIs at worldwide level are attributable to bacterial contamination of medical devices and polymeric implants (Kenawy, E., Worley, S. D., Broughton, R. 2007. The Chemistry and Applications of Antimicrobial Polymers: A State-of-the-Art Review. Biomacromolecules 8(5): 1359-1384).

In Europe, 50 thousand yearly deaths were notified as HAI product (BioMérieux, 2007, BioMérieux confirms its commitment to the fight against Hospital Acquired Infections. Press Releases. http://www.biomerieux.com). In the USA nearly 2 million cases are reported annually and 90 thousand deaths are still the fourth cause of death in the country, after heart diseases, cancer and strokes. Recent reports estimate that these diseases have an associated cost of US$4.5 to 11 billion in medical expenses, including extra hospital stay (Samuel, S. O., Kayode, O. O, Musa, O. I., Nwigwe, G. C., Aboderin, A. O., Salami, T. A. T., Taiwo, S. S. 2010. Nosocomial infections and the challenges of control in developing countries. African Journal of Clinical and Experimental Microbiolgy 11(2): 102-110). In the particular case of Chile, nearly 70 thousand HAI are reported annually and each HAI prolongs hospital stay in an average of 10 days with a cost of 70 million US dollars. Main pathogens responsible for HAIs in Chile are Staphylococcus aureus (MRSA), Pseudomonas aeruginosa and Acinetobacter baumanii (Bustamante R, Espinola, V. 2007. Informe de vigilancia epidemiólogica de infecciones hospitalarias. Departamento de calidad y seguridad del paciente, División de integracion de redes, Ministerio de Salud de Chile. Report of epidemiologic surveillance of hospital-acquired infections. Quality and Safety patient department, Network integration division, Chilean Health Ministry).

To confer biocidal activity to conventional materials, numerous types of organic and inorganic biocidal additives have been developed, that incorporate in the bulk or on the surface of the material. Additive is understood as a substance that is added to others to grant properties that they lack or to improve the ones that they already have.

Additives consist on inorganic species, such as salts or particles of an antimicrobial metal (mainly silver, copper, zinc, and tin), different structures based on titanium oxides (TiO₂) and zinc oxides (ZnO), and organic species based in active principles such as thiabendazole, octylisothiazolinone, and triclosan. Incorporation of organic type additives is achieved by direct incorporation to a material or by immobilizing in a material by ionic or covalent bonds, while inorganic additives are immobilized physically by being embedded in a material or are incorporated by surface treatment techniques to the material. Organic additives are widely used due to their low cost, which compensates their low spectrum of antimicrobial action, weak performance in long term, and high degradation in standard production methods of the materials.

For years additives using inert substrates or carriers or materials that can adsorb some active agent have been developed. Currently, zeolites are the most used carriers. Metallic ions contained in zeolite are replaced by metallic ions with biocidal properties through ionic exchange, mainly silver, copper, and/or zinc biocidal ions. These additives have a good biocidal activity, better action spectrum and longer duration, when compared to organic additives. Nevertheless, the amount of biocidal ions that can be incorporated into these carriers is limited by the ions originally present therein, limiting their biocidal performance.

In order to solve the aforementioned problems, the present invention is referred to a biocidal additive conformed by a carrier and a high concentration of active biocidal agent. The pure or incorporated action mechanism to some material consists on reacting the active biocidal agent with functional groups present in the microorganism. This could cause defects in the nucleic acid structure (DNA, RNA) and proteins, spoiling the microorganism until its elimination. On the other hand, the active agent has affinity for DNA (deoxyribonucleic acid), damaging it and preventing reproduction of the microorganism. This biocidal additive acts on a wide spectrum of microorganisms, such as bacteria, virus, protozoa, algae, fungi, and yeast.

### PRIOR ART

There are some related patents in prior art, related to biocidal additives that can be incorporated into different materials, that are described in here below.

U.S. Pat. No. 7,202,293 describes a resin mixed with at least two antimicrobial agents that grant antimicrobial activity. Among the antimicrobial agents, zeolite with metallic silver, copper, zinc, or tin antimicrobial ions is mentioned. It has a restriction of using at least two antimicrobial agents to confer the antimicrobial activity to the resin.

U.S. Pat. No. 8,361,513 describes manufacturing of antimicrobial zeolite and its incorporation into a resin to form an antimicrobial resin composition. This disclosure is limited to a zeolite with exchangeable ions that are substituted with hydrogen ions, silver ions, and if required, other antimicrobial metallic ions. Also, the composition of antimicrobial resin comprises the mentioned antimicrobial zeolite in an amount varying from 0.05 to 80% in weight.

U.S. Pat. No. 8,232,221 is limited to a material formed by chabazite or similar structures and metallic silver, nickel, copper, gold, or other metal of the platinum group, nanodots. This document is directed to nanodots or nanometric structures of sizes from 100 nm and in average 3 nm, that is mainly different in size and location of the structures compared to the present invention, since in the present invention the nanostructures are located in the surface of the carrier, unlike U.S. Pat. No. 8,232,221. Also, the production methods are different, since U.S. Pat. No. 8,232,221 describes a ionic exchange step, followed by activation at a predetermined temperature, while the present invention requires the use of a reducing agent and does not require activation at a predetermined temperature.

U.S. patent application 60/71542 describes an antibacterial zeolite supporting an antibacterial metal in a concentration from 0.5 to 20% in weight, and further comprising an oligomer with aryl groups, or an organopolysiloxane, and a water soluble acid. Finally, the material corresponds to a zeolite with an organic polymer with antimicrobial properties.

Zielecka et al (Progress in Organic Coatings 72 (2011) 193-201) describe the properties of copper and silver supported in silicon nanomaterials, nevertheless, there is no description of features of the charge on the external surface of the nanoparticle, as described in the present invention.

Unlike the previously cited documents, in the present invention, the biocidal additive is synthesized through a process including a reducing agent, and also, in the present invention the biocidal agent is essentially forming nanostructures on the external surface of the support or inert carrier, and similar to the prior art, can also be ionically adsorbed inside the support or carrier. The obtained additive possesses biocidal activity.

This difference allows increasing the charge of the biocidal agent in the supporting material or carrier, allowing a greater release rate of the biocidal agent at shorter times, together with maintaining the release of those agents in time, which is translated in a longer duration of biocidal properties in the matrixes to which the additive of the present invention is added.

### DESCRIPTION OF FIGURES

FIG. 1. Representative microphotography, taken using a transmission electron microscope (TEM), of a nanometric silicate (approximate size of 150 nm) with the active biocidal agent. The active biocidal agent is found as copper nanostructures (of approximate size of 20 nm) on the external surface of the silicate.

FIG. 2. Representative microphotography, taken using a transmission electron microscope (TEM), of a micrometric zeolite (approximate size of 1 μm) with the biocidal agent. The active biocide is found as copper nanostructures (approximate size 10 nm) on the external zeolite surface.

FIG. 3. X-ray diffractogram (XRD) representative of nanometric silicate with the biocidal agent. In this figure, the active biocide agent supported on the external surface of the silicate is shown, corresponding to paratacamita or copper oxychloride Cu₂Cl(OH)₃.

FIG. 4. Plot comparing copper ions release (measured through spectrophotometry) from biocidal additive obtained according to the present invention, and conventional biocidal additive. In the biocidal additive of the present invention, the biocide agent forms nanostructures on the external surface of the zeolite, while in the conventional biocidal additive, the biocidal active agent is ionically adsorbed inside the zeolite.

FIG. 5. Plot showing release of copper ions, for two concentrations of the biocidal additive obtained according to the present invention and incorporated from a polymeric master-batch to a thermoplastic poly vinyl chloride (PVC) resin.

FIG. 6. Plot showing copper ions release, for two concentrations of the biocidal additive obtained according to the present invention and incorporated from a suspension to a thermostable foam polyurethane (PU) resin.

FIG. 7. Plot showing the release of copper ions, from biocidal additive obtained according to the present invention and incorporated as a powder to a polyurethane (PU) coating.

### SUMMARY OF THE INVENTION

The present invention is related to an additive with biocidal properties based on an active agent with antimicrobial and antifouling properties, wherein the additive corresponds to a supporting material, inert substrate or carrier, which has been modified with antimicrobial agents. The invention further describes the method for modifying the supporting material, inert substrate or carrier, with antimicrobial agents. The resulting additives have a biocidal activity, and can be incorporated in different matrices, such as polymeric resins, either natural or synthetic, thermoplastic or thermostable, organic coatings, ceramics, paintings, varnishes and coatings, granting biocidal activity to those matrices.

### DETAILED DESCRIPTION OF THE INVENTION

As previously mentioned, the present invention is related to an additive with biocidal properties based on a supporting material that is modified with a biocidal agent. In particular, the supporting material, inert substrate or carrier, can be chosen among organic or inorganic materials, of a nanometric or micrometric size, either natural or synthetic. In a particular embodiment, the supporting material, inert substrate or carrier, of a nanometric and micrometric size can have a nanometric or micrometric size, and can be zeolite, silicates, sepiolite, dolomite, wollastonite, mica, ceramics, carbon, activated charcoal, clay, hydroxyapatite, kaolin, talc, calcium carbonate, pumice stone, natural and synthetic fibers, coir.

The biocidal agent used to modify the supporting material has a wide spectrum of antimicrobial action against microorganism such as bacteria, virus, protozoa, algae, fungi, and yeast. The biocidal agent can be found in the supporting material as adsorbed ions, exchanged ions, and nanostructures, or only as nanostructures, providing an effective performance and duration in time for the biocidal action. In an embodiment of the present invention, the biocidal agent modifying the supporting material is selected among compounds based on copper, silver, zinc, gold, bismuth, mercury, tin, antimony, cadmium, chromium, tantalum, iron, manganese and lead, their oxides, hydroxides, acetates, carbonates, chlorides, nitrates, phosphates, sulfates, sulfides, and mixtures thereof. In an even more particular embodiment, the biocidal agent modifying the supporting material is a salt of copper, silver, zinc, gold, bismuth, mercury, tin, antimony, cadmium, chromium, tantalum, iron, manganese and/or lead.

The present invention also considers the method for generating the biocidal additive, based on a supporting material or carrier and a compound based on copper, silver, zinc, gold, bismuth, mercury, tin, antimony, cadmium, chromium, tantalum, iron, manganese and lead with an antimicrobial activity. More particularly, the biocidal agent modifying the supporting material is an inorganic salt of the antimicrobial metal, such as for example acetate, chloride, sulfate, nitrate and the like, or their combinations. The process can be applied to obtain a variety of formulations of biocidal additives.

Modifying the supporting material or carrier with an agent with biocidal properties is performed through ionic exchange and ionic adsorption in the bulk of the supporting material; and formation of nanostructures on its surface, or only as nanostructures on its surface. The resulting nanostructures can be found in metallic state, such as oxides, hydroxides, acetates, carbonates, chlorides, nitrates, phosphates, sulfates, sulfurs, or mixtures thereof. The exchanged ions, adsorbed ions, and supported nanostructures have biocidal activity. The method of the present invention can be applied to obtain a variety of biocidal additives.

The process consists on modifying organic or inorganic materials, selected among micro and nano particles such as zeolite, silicates, sepiolite, dolomite, wollastonite, mica, ceramics, carbon, activated charcoal, clay, hydroxyapatite, kaolin, talc, calcium carbonate, pumice stone, natural and synthetic fibers, coir, that are generally considered as supporting materials or carriers due to their capacity to adsorb and support other materials. In particular, the additive of the present invention, i.e. the supporting material or carrier modified with an antimicrobial agent, can be incorporated into different matrices, such as natural or synthetic polymeric resins, thermoplastic or thermosetting, organic coatings, paints, varnishes, lacquers, coatings, gels, oils, waxes, ceramics, among others, granting them biocidal activity.

The biocidal additive of the present invention has sizes varying from 10 nm to 100 micrometers, regardless of their morphology. The size is selected depending on the field of application. The biocidal additive can be found as a powder, in a suspension, or as a polymeric master-batch. The biocidal additive comprises between 0.1 to 40% w/w of an active inorganic biocide, more preferably between 1% to 35%, more preferably between 5% to 30%, more preferably from 10% to 25% and even more preferably from 15% to 20% w/w. The biocidal additive confers biocidal activity to a matrix when loaded in a range from 0.1 to 50% w/w, or from 0.5% to 40%, or from 1% to 30% w/w. The additive can also be used pure in the form of a powder, or in a suspension containing the additive in a range from 0.1 to 70% w/w, or from 1% to 60% w/w, or from 5% to 50% w/w.

The biocidal additive has a large biocidal surface area per volume unit and mass, decreasing unprotected zones with no biocide, and granting stability when dispersed in low density solutions or matrices or precursors. The additive does not present changes in coloring in time. It is resistant to outdoors, heat, and light, and has a good processability.

The present invention also considers the method for preparing the biocidal additive, according to the following considerations:

An inorganic biocidal agent (A) is defined as compounds based on copper, silver, zinc, gold, bismuth, mercury, tin, antimony, cadmium, chromium, tantalum, iron, manganese and lead, their oxides, hydroxides, acetates, carbonates, chlorides, nitrates, phosphates, sulfates, sulfides, and mixtures thereof, presenting biocidal activities.

The supporting material or carrier (B) correspond to organic or inorganic materials, selected among zeolite, silicates, sepiolite and dolomite, wollastonite, mica, ceramics, carbon, activated charcoal, clay, hydroxyapatite, kaolin, talc, calcium carbonate, pumice, natural or synthetic fibers, coir.

The present invention further considers the method for preparing or synthesizing the biocidal additive, wherein the steps are indicated below:

### Method of the Present Invention to Obtain a Biocidal Additive

a. preparing a suspension in deionized or distilled water with an amount of supporting material or carrier (B) in a ratio from 1 to 30 g per each 100 mL deionized or distilled water;
b. add an amount of biocidal agent (A) such that the aqueous suspension of the prior step containing B, is in a ration wherein 0.1<(A)/(B)<5, wherein (A)/(B) corresponds to the weight ratio between the biocidal agent and the supporting material or carrier;
c. add a reducing agent (C), in a ratio, such that 0.1<(C)/(A)<5, wherein (C)/(A) corresponds to the weight ratio between the reducing agent and the biocidal agent
d. mix using for example agitation between 500 to 2000 rpm during a period from 1 to 10 hours;
e. filter the resulting aqueous composition under vacuum, and dry at a temperature between 100 to 120° C.

The previously described process (steps a, b, c, d, and e), allows forming and incorporating nanostructures of an active biocidal agent into the external surface of the supporting material (B).

In step c), the reducing agent can be selected, just as an example, among ammonium hydroxide (NH₄OH), sodium hydroxide (NaOH), trisodium citrate (Na₃C₆H₅O₇.2H₂O), Sodium Sulfoxylate Formaldehyde (CH₃NaO₃S), sodium borohydride (NaBH₄) and hexadecyltrimethylammonium bromide (C₁₉H₄₂BrN).

Optionally, before elaborating the biocidal additive of the present invention, the supporting material or carrier (B) can be conditioned in order to eliminate contaminant elements that do not have biocidal activity. As an example, and without intention on limiting the scope of the present invention, among the conditioning processes for the supporting material or carrier are:

### Conditioning Method

add (B) to an aqueous solution containing NaCl in a weight ratio between 0.1<NaCl/(B)<1, mixing between 100-1,000 rpm from 2 to 48 hours.

Optionally, after the conditioning step of supporting material or carrier (B), if appropriate, and prior to obtaining the biocidal additive, the supporting material or carrier (B) can be pre-treated in a general manner with processes similar to the ones exposed in prior art. The pre-treatment allows adsorption of biocidal ions in the available space inside the supporting material or carrier (B). As an example, this can be achieved by following a pre-treatment method:

### Pre-Treatment Method

After an optional conditional step, as previously described, steps a) and b) of the method of the present invention can be repeated allowing mixing from 100 to 1000 rpm during a period of time from 1 to 24 hours, at a temperature between 15 to 50° C.:
a) preparing a deionized or distilled water suspension with an amount of supporting material or carrier (B) in a ratio from 1 to 30 grams per each 100 mL of deionized or distilled water;
b) adding to the aqueous suspension of the previous step containing B, an amount such that the biocidal agent (A), is in a ratio 0.1<(A)/(B)<10, wherein (A)/(B) corresponds to the ration between the weights of the biocidal agent and the supporting material or carrier;
   Once the time period is completed, the pre-treatment method can follow in two different manners:
      Continuous step: the mixture is reserved to directly continue to step c) of the method of the present invention, obtaining a biocidal additive, following steps d) and e) of said method
      Batch step: washing the mixture with deionized or distilled water, filtering and drying at a temperature from 25 to 150° C. during a period of time from 1 to 8 hours, until obtaining a dry powder. The obtained dry powder is used as a “supporting material or carrier” mentioned in step a) of the method of the present invention to obtain a biocidal additive, and following steps b), c), and d) until obtaining the biocidal additive of the present invention, which further comprises the biocidal agent adsorbed inside the inner space of the supporting material or carrier.

### EXAMPLES

### Examples for Biocidal Additive Formulation

The following described Example was made using zeolite or a silicate as supporting material or carrier:
2 g zeolite or silicate were added to 200 mL of distilled water;
2 g copper chloride (CuCl₂) were added as biocidal agent.
The mixture of the previous step was agitated at 1000 rpm for 24 hours at room temperature;
A pre-treatment batch step was considered, wherein the obtained material was washed with distilled water, filtered and further dried at 120° C. for 3 hours, obtaining a dry powder;
To the powder obtained in the previous step, 200 mL distilled water and 1 mL of a solution of ammonium hydroxide (NH₄OH) was added as a reducing agent.
The mixture was agitated at 1000 rpm for 6 hours.
The resulting solution was vacuum-filtered and further dried for 3 hours at 120° C.

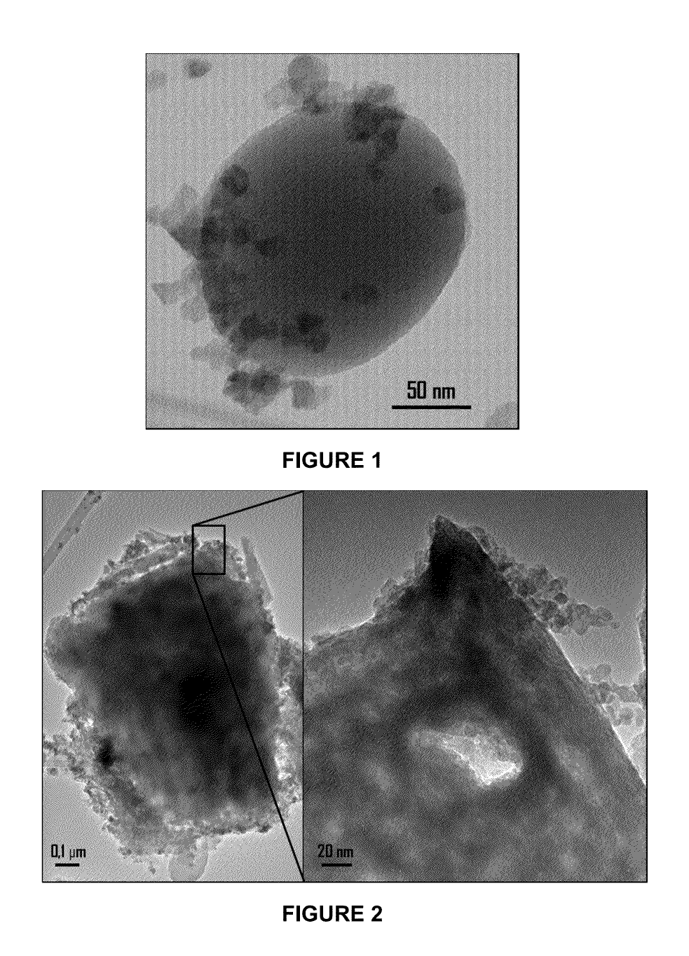

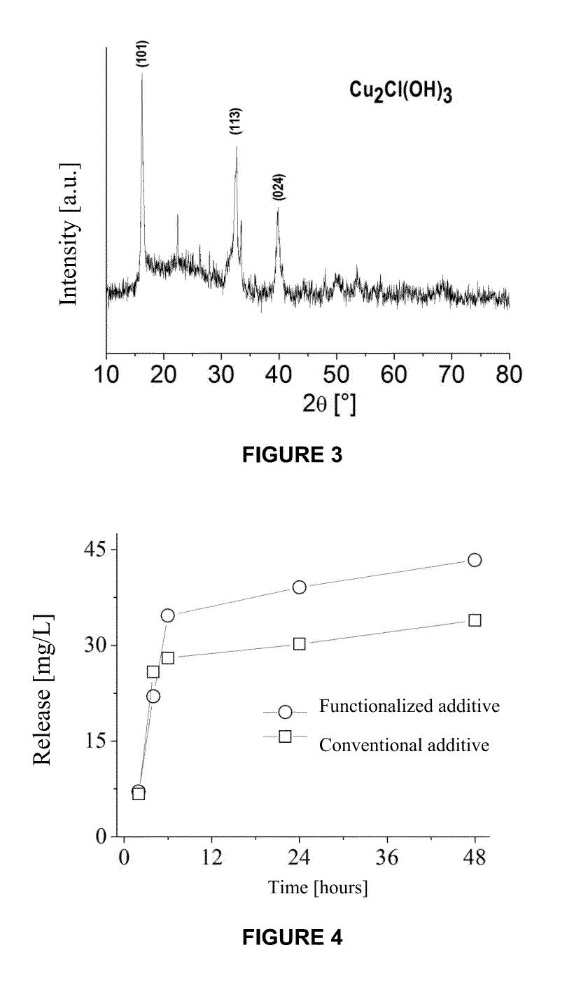

FIG. 1 shows nanostructures with an approximate size of 20 nm, which are supported all over the surface of a silicate of average size of 150 nm. The nanostructures present a good distribution and correspond to paratacamite or copper oxychloride nanocrystals, according to the diffractogram shown in FIG. 3. These crystals present the biocidal activity.

FIG. 2 show nanostructures based on copper with an approximate size of 10 nm which are supported on the surface of a zeolite of an average size of 1 μm. The nanostructures are dispersed covering all the surface of the zeolite. These nanostructures present biocidal activity.

FIG. 3 shows a representative diffractogram of a nanometric silicate according to the example, using X-ray diffraction (XRD) to produce it. In this figure, nanostructures supported on the silicate correspond to paratacamite or copper oxychloride Cu₂Cl(OH)₃.

On the other hand, FIG. 4 compares the cumulative release of copper ions between a conventional additive and a biocidal additive according to the present invention. A conventional additive must be understood as a modified zeolite, prepared according to prior art, wherein metallic ions contained in the zeolite where exchanged by copper ions. For comparison reasons, the zeolites used as support for the conventional additive has the same features as the zeolite used in the present invention.

It can be seen that the biocidal additive according to the present invention achieves a higher release rate at shorter times (first 2 days), compared to conventional additive. Approximately a 40% increase in the release rate of the biocidal additive is obtained, when compared to a conventional additive.

### Examples for Using the Biocidal Additive

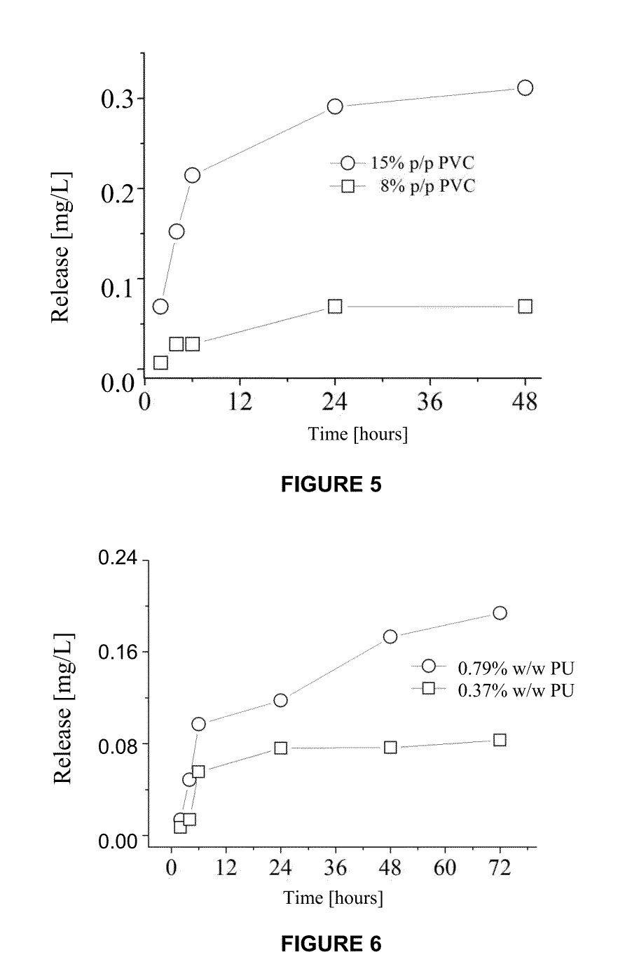

As an example, and with no intention on limiting the scope of the present invention, the biocidal additive of the present invention was incorporated from a polymeric master batch to a polyvinyl chloride (PVC) thermoplastic matrix. Two concentrations were selected. FIG. 5 shows that the material can release biocidal copper ions, and also, it is observed that the release of ions increases in time as well as with the biocidal additive concentration.

Furthermore, and as an example, the biocidal additive of the present invention was incorporated as a dry powder into a polyurethane (PU) foam thermostable matrix. FIG. 6 shows the release of copper ions. Just as with the previous example, two concentrations were selected and it was observed that the release of copper ions increases in time as well as with the additive concentration.

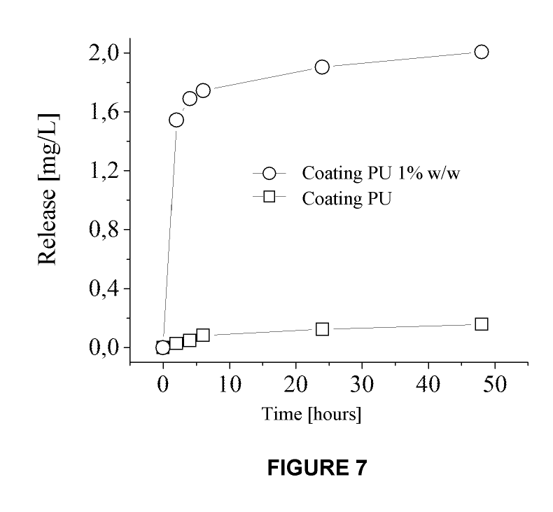

Also, the biocidal additive of the present invention was incorporated from a polyurethane (PU) suspension coating. FIG. 7 shows that the release of copper ions increases in time and that the polyurethane (PU) coating with no added biocidal additive does not release copper ions.

### Examples of Antimicrobial Properties

The biocidal additive was incorporated into thermoplastic, thermostable resins and in coatings during manufacturing processes. The antimicrobial properties of the obtained materials were assessed according to ISO norm 22196:2011. The bacteria used were Escherichia coli (ATCC 25922). The following table lists the samples and the application, type of resin used, biocidal additive percentage added, and decrease in the number of initial bacteria.

TABLE 1
Antimicrobial activity after 24 hours contact of the
bacteria. Initial Escherichia coli (ATCC 25922) concentration
was approximately 1 ± 0.5 × 10⁵ CFU/mL.

| | | | Biocidal | |
|---|---|---|---|---|
| Sample | | | additive | % |
| No | Application | Resin type | [% w/w] | Reduction |
| 1 | Upholstery | Polyvinyl | 15 | 99.7 |
| | | chloride (PVC) | | |
| 2 | Sponges | Polyurethane | 0.37 | 99.7 |
| | | (PU) sponges | | |
| 4 | Shower coatings | Gel coat | 2.5 | 99.8 |
| 5 | Interior paint | Enamel | 0.1 | 99.8 |

It is demonstrated that the presence of low amounts of the biocidal additive grant a high antimicrobial activity to the material, decreasing the bacterial concentration in more than 99%.

### INDUSTRIAL APPLICATION

The additive of the present invention allows granting biocidal properties to different materials, such as natural or synthetic, thermoplastic or thermostable polymeric resins, organic coatings, paints, varnishes, lacquers, coatings, gels, oils, waxes, ceramics, among others, with large application in different industries.

1. Additive with antimicrobial properties for adding to natural or synthetic, thermoplastic or thermostable, polymeric resins, organic coatings, paints, varnishes, lacquers, coatings, gels, oils, waxes, ceramic materials, comprising a supporting material or carrier selected among nanometric or micrometric size organic or inorganic, natural or synthetic materials, modified with an antimicrobial agent, wherein the antimicrobial agent is selected among copper, silver, zinc, mercury, tin, iron, manganese, or lead derived materials, and wherein the antimicrobial agent forms nanometric structures on the external surface of the supporting material or carrier.

2. Additive according to claim 1, wherein the supporting material or carrier is micro- or nano-metric, and is selected among zeolite, silicates, sepiolite, dolomite, wollastonite, mica, ceramics, carbon, activated charcoal, clay, hydroxyapatite, kaolin, talc, calcium carbonate, pumice stone, natural and synthetic fibers, coir.

3. Additive according to claim 1, wherein the antimicrobial agent is derived either from copper, silver, zinc, mercury, tin, iron, manganese or lead, and corresponds to a compound that is an acetate, chloride, sulfate, nitrate, hydroxide, carbonate salt of either copper, silver, zinc, mercury, tin, iron, manganese or lead.

4. Additive according to claim 1, wherein the nanometric structures formed on the external surface of the supporting material or carrier are in a metallic state, or as oxides, hydroxides, acetates, carbonates, chlorides, nitrates, phosphates, sulfates, sulfurs, or mixtures thereof.

5. Method for preparing an additive with biocidal properties for adding to natural or synthetic, thermoplastic or thermostable, polymeric resins, organic coatings, paints, varnishes, lacquers, coatings, gels, oils, waxes, ceramic materials, wherein the method comprises the steps of:
a. preparing a suspension with deionized or distilled water and an amount of a supporting material or carrier (B) in a ratio of 1 to 30 grams per each 100 mL of deionized or distilled water;
b. adding an amount of a biocidal agent (A) to the suspension of the previous step containing (B) in a ration such that 0.1<(A)/(B)<5, wherein (A)/(B) corresponds to the weight ratio between the biocidal agent and the supporting material or carrier;
c. adding a reducing agent (C), in a ratio such that 0.1<(C)/(A)<5, wherein (C)/(A) corresponds to the weight ratio between the reducing agent and the biocidal agent;
d. mixing using for example agitation between 500 and 2000 rpm for a period between 1 and 10 hours, resulting in an aqueous composition;
e. vacuum-filter the resulting aqueous composition, and dry at a temperature between 100 and 120° C.

6. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 5, wherein in step c) the reducing agent (C) is selected among ammonium hydroxide (NH₄OH), sodium hydroxide (NaOH), trisodium citrate (Na₃C₆H₅O₇*2H₂O), sodium formaldehyde sulfoxylate (CH₃NaO₃S), sodium borohydride (NaBH₄) and hexadecyltrimethylammonium bromide (C₁₉H₄₂BrN).

7. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 5, wherein before step a) the supporting material or carrier (B) is conditioned using a conditioning process in order to eliminate contaminant elements with no biocidal activity.

8. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 7, wherein the conditioning process for the supporting material or carrier correspond to adding the supporting material or carrier (B) to an aqueous solution containing NaCl in a ratio 0.1<NaCl/(B)<1 and mixing at 100-1000 rpm for 24 hours.

9. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 5, wherein before step a) the supporting material or carrier (B) is subjected to a pre-treatment method.

10. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 9, wherein the pre-treatment method comprises the steps of:
a. preparing an aqueous composition in deionized or distilled water with an amount of supporting material or carrier (B) in a ratio of 1 to 30 grams per each 100 mL of deionized or distilled water;
b. adding an amount of biocidal agent (A) to the aqueous composition of the previous step containing (B), in a ratio such that 1<(A)/(B)<10, wherein (A)/(B) correspond to the weight ratio between the biocidal agent and the supporting material or carrier;
c. mixing at 100 to 1000 rpm for a period of time from 1 to 24 hours at a temperature from 15 to 50° C.

11. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 10, wherein the pre-treatment method is followed by a continuous step:
d. the resulting mixture is reserved to continue directly to step c) wherein nanometric structures formed on the external surface of the supporting material or carrier are in a metallic state, or as oxides, hydroxides, acetates, carbonates, chlorides, nitrates, phosphates, sulfates, sulfurs, or mixtures thereof.

12. Method for preparing an additive with biocidal properties for adding to natural or synthetic, thermoplastic or thermostable, polymeric resins, organic coatings, paints, varnishes, lacquers, coatings, gels, oils, waxes, ceramic materials, according to claim 10, wherein the pre-treatment method is followed by a batch step:
d. washing the resulting mixture with deionized or distilled water;
e. filtering and drying at a temperature between 25 to 150° C. for a period of time from 1 to 8 hours until obtaining a dry powder, wherein said dry powder is used as a supporting material or carrier in step a) and wherein nanometric structures formed on the external surface of the supporting material or carrier are in a metallic state, or as oxides, hydroxides, acetates, carbonates, chlorides, nitrates, phosphates, sulfates, sulfurs, or mixtures thereof.
